(19) United States
(12) Patent Application Publication
(10) Pub. No.: US 2004/0250422 A1
(43) Pub. Date: Dec. 16, 2004

(54) Coating of heat exchanger tubes

(75) Inventors: Amer Faisal Ali, Jamesville, NY (US); Daniel P. Gaffaney, Chittenango, NY (US)

Correspondence Address: Dana F. Bigelow, WALL MARJAMA & BILINSKI LLP, Suite 400, 101 South Salina Street, Syracuse, NY, 13202, US

(73) Assignee: Carrier Corporation

(21) Appl. No.: 10/462,173

(22) Filed: Jun. 16, 2003

(51) Int. Cl. B23P 15/26; B21D 53/06

(52) U.S. Cl. 29/890.047

(57) ABSTRACT

In the manufacture of a fin and tube heat exchanger coil, a protective coating is applied to selective portions of the tubing in order to prevent corrosion of the fins due to galvanic corrosion and/or to prevent corrosion of the tubing due to formicary corrosion. The coating is applied to selective portions of the tube to include that portion that comes in direct contact with the plate fins or would be exposed to condensate and excluding that portion which is subsequently brazed to return bends.

### BACKGROUND OF THE INVENTION

This invention relates generally to fin and tube type heat exchangers and, more particularly, to a method and apparatus for the coating of tubes therefor.

The problem that has long challenged the air conditioning industry is that of corrosion of the components of heat exchangers. This is particularly true for the fin and tube heat exchangers, wherein the plate fins are in close contact with the refrigerant carrying tubes. The problem is exacerbated by those elements being composed of different metals, the most common being of the type wherein copper tubes are received in openings in aluminum plate fins. This is a valid expression for galvanic corrosion, but not for formicary corrosion.

There are generally two types of corrosion that occur. In galvanic corrosion, the dissimilar metals and an electrolyte combine to form a battery or galvanic cell that causes corrosion of the anodic material. In the common construction of fin and tube type heat exchangers, the anodic material will be the aluminum fin. The electrolyte is water that contains materials that have been dissolved or absorbed from the environment (such as salts, sulfur dioxide, and other pollutants).

Another type of corrosion that has only recently become recognized as a problem is that of formicary corrosion. This is corrosion of copper by short chain organic acids such as formic, acidic or propionic acid. The precursors of these acids are released from construction materials (e.g. particle board, carpeting and adhesives) and from other materials or activities. As buildings have tended to be more tightly sealed, and as new types of materials have been created, this problem has become more pronounced.

One solution in dealing with the corrosion problem, particularly with respect to galvanic corrosion, has been to coat one or both of the components (i.e. either the tubes or the plate fins, or both) with a protective coating to significantly retard the corrosion process. One such method is described in U.S. Pat. No. 6,325,138, assigned to the assignee of the present invention, wherein a coating is applied to the tubes of a heat exchanger.

In order to coat the tubes for heat exchanger use, it is desirable to coat the tube during the tube manufacturing process by simply adding another step at or near the end of the production line. However, this has been found to be difficult and expensive to implement since it would not be used in the fabrication of all of the tubes coming off the production line. That is, because it would be added as an optional process that is occasionally applied to an otherwise rather extensive manufacturing process, it is generally not economical feasible for a tube manufacturing company to implement the process.

Another approach might be to implement the coating process as a stand along operation after the tubing has been formed and coiled. One problem with this approach is that the tubing would first have to been uncoiled, coated, and then recoiled to be shipped to the heat exchanger manufacturer. The problem with this approach is that the cold working, that occurs with the uncoiling and recoiling, tends to harden the tubing material and cause later problems in the processing of the tubing. That is, while the tubing has been annealed during the manufacturing process, and a cold working of the tubing will then tend to harden the tubing. Accordingly, excessive cold working such as, for example, the recoiling of the tubing, should be avoided. Problems that occur when working with hardened tubing include that of reduction of thermal contact between tube and fin (springback during the expansion process), or splitting of the tube ends when the bell is formed at the end of the expansion step, or problems in hairpin forming.

One concern with the use of some tube coatings is that, while it does reduce the occasion of corrosion, it also impedes the transfer of heat. This is particularly the case when organic coatings are employed since they are insulators. It is therefore desirable to minimize the thickness of the coating and to apply it uniformly to the tubing.

Another concern is that the coating may interfere with the subsequent attachment of the hairpin tubes to the return bends. Metallic coatings may alloy with or dissolve the tubing material. Organic coatings will degrade during thermal bonding processes and their degradation may prevent adequate bonding of the tubular components.

It is therefore an object of the present invention to provide an improved method and apparatus for the coating of heat exchanger tubes.

Another object of the present invention is the provision for the coating of the heat exchanger tubing without excessive cold working of the tube.

Yet another object of the present invention is the provision for a tube coating process which does not interfere with the subsequent joining process.

Still another object of the present invention is the provision for a heat exchanger tube coating process that is economical and effective in use.

These objects and other features and advantages become more readily apparent upon reference to the following description when taken in conjunction with the appended drawings.

### SUMMARY OF THE INVENTION

Briefly, in accordance with one aspect of the invention, the coating of the tube is accomplished at a point in a process after the tubing has been cut to the desired length and the hairpins have been formed.

By another aspect of the invention, a coating chamber is provided to receive the hairpin therein in order to apply the desired coating. This coating chamber may apply any of a number of coating systems (metallic, organic, and possibly inorganic) utilizing a variety of coating methodologies (e.g. spray, dip, vapor deposition and plating) and will include the means of curing, drying or cooling the coating. It includes a wiping structure at the entrance/exit position in order to remove any excess coating material.

By yet another aspect of the invention, the hairpins are not entirely coated, but rather their open ends are left uncoated for the purpose of facilitating a better brazing process.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is a fin and tube heat exchanger of the type in which the present invention is applicable.

FIG. 2 is a schematic illustration of a coating process in accordance with the present invention.

FIG. 3 is a perspective view of the step in the process wherein the hairpins are coated in a coating chamber in accordance with the present invention.

FIG. 4 is a side view of a hairpin being belled to accommodate the subsequent brazing operation.

### DESCRIPTION OF THE PREFERRED EMBODIMENT

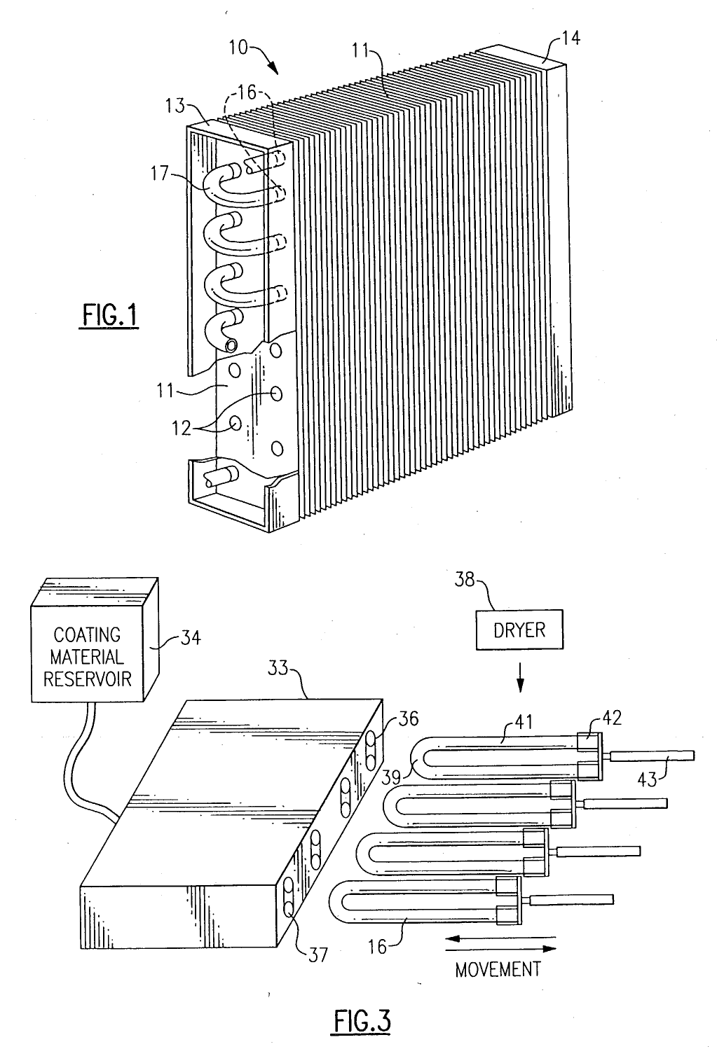

Referring now to FIG. 1, there is illustrated a fin and tube heat exchanger in accordance with a preferred embodiment of the present invention. Heat exchanger coil 10 comprises a plurality of spaced apart plate fins 11 wherein each plate fin 11 has a plurality of holes 12 formed therein. Plate fins 11 are held in a tight fit, parallel relationship by being sandwiched between the inner sides of tube sheets 13 and 14 having holes therethrough in axial alignment with the holes 12. A plurality of hairpin tubes 16 are laced through select pairs of holes 12 as illustrated and have their open ends joined together in fluid communication by return bends 17 which are secured to the hairpin tubes 16 by soldering or brazing or the like to serially interconnect the adjacent hairpins into circuits for the flow of refrigerant therethrough.

In operation, a first fluid to be cooled or heated flows, through hairpin tubes 16 and the cooling or heating fluid is then passed between the plate fins 11 and over the tubes 16 in a direction indicated by the arrow. Heat energy is transferred from or to the first fluid through the hairpin tubes 16 and plate fins 11 to or from the other fluid. The fluids may be of various types. For example, the fluid flowing through the tubes 16 may be a refrigerant and the fluid flowing between the plate fins 11 and over the tubes 16 may be air.

As illustrated in FIG. 1, the plate fin tube heat exchanger coil 10 is a staggered two row coil since each plate fin 11 has two rows of staggered holes therein for receiving hairpin tubes. Even though not shown, the present invention contemplates the heat exchanger coils of only one row of tubes or more than two rows of tubes, and with holes 12 of one row in staggered relationship with holes 12 of an adjacent row. Also, multiple row coils can be formed either from a plurality of multiple row single plate fins or a composite of a plurality of single row coils.

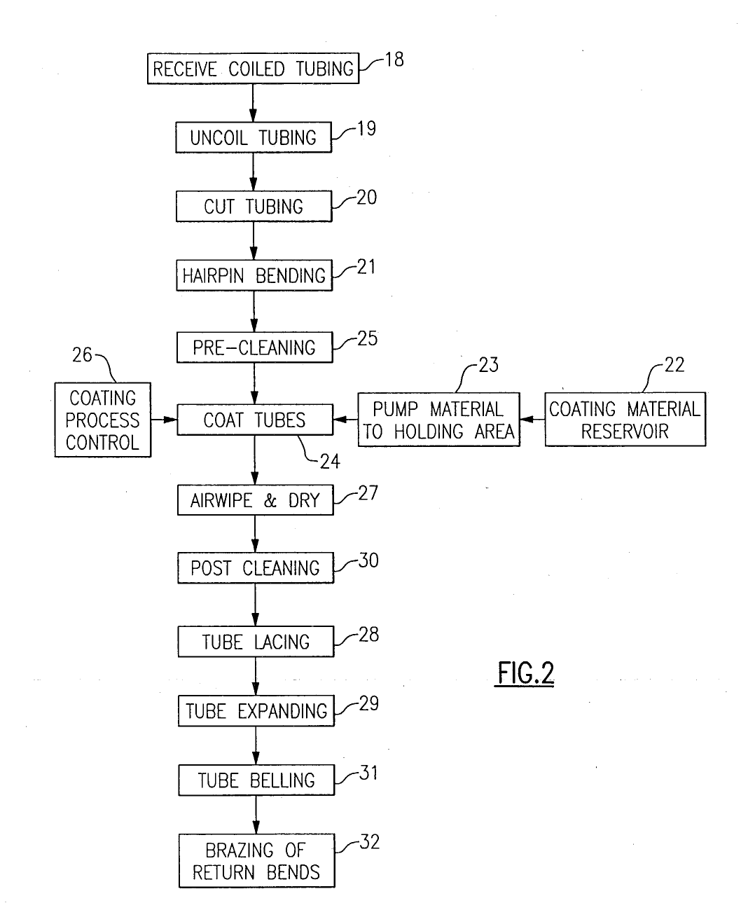

Having described the structure in general, the process of assembly will now be described. As shown in FIG. 2, the coiled tubing is received from the tube fabrication vendor at step 18. When ready for use, the tubing is uncoiled at step 19. Since the tubing was “level wound” so as to make the coil as dense as possible, it is somewhat oval in shape and must be made round again before further processing. For that purpose, it is preferably passed through straightening rollers as it is uncoiled.

In step 20, the tubing is then cut by a tube cutter to the desired length for straight length tubes to be further processed, or, more commonly, formed into hairpins which takes place at a dedicated hairpin bender in a conventional manner at step 21. A pre-cleaning process is then applied to either the straight length tubes or the hairpins as shown at block 25. If the tubes are not formed into hairpin tubes but are left as straight tubes, the process of coating is completed as shown in FIG. 2 and then return bends are brazed to each end thereof.

In a parallel process, a coating material is provided in a reservoir at step 22. Any of various coating material types such as metallic, organic or inorganic may be used as appropriate. Tin, aluminum, zinc, and other such materials or their alloys would be some choices for coating materials to be applied to copper or copper alloy tubing. In step 23 the coating material is pumped from the reservoir to the coating station at 24. This step will be more fully described in respect to FIG. 3 below. The process of applying the coating material may be by a hot dip, vapor deposition, metal spray or plating as desired. During the process, certain control criteria and procedures are applied at step 26 in order to obtain the desired results. In this regard, the teachings of U.S. Pat. No. 6,325,138 are applicable and that patent is incorporated herein by reference. At the end of the coating process, a mechanical wiping structure may be applied to wipe any excess coating material from the hairpin and a curing process such as drying or the like may be applied to cure the coating at step 27. A post cleaning process is then preferably applied at step 30.

Once the coating has been applied, the conventional steps of lacing the tubes in step 28, expanding the tubes to make the necessary contact with the surrounding plate fin at step 29, the tube belling at 31 and the brazing of the return bends at 32 is accomplished in a somewhat conventional manner.

Shown in FIG. 3 is a schematic illustration of one possible approach for coating the hairpin tubes 16 in accordance with the present invention. A coating chamber 33 is provided with a coating material from a reservoir 34. A plurality of openings 36 are provided in the front of the coating chamber 33 for purposes for inserting the hairpin tubes 16 therein for purposes of applying the coating to the outer surfaces of the tubes. The openings 36 have a surrounding structure and material that is suitable for wiping the excess coating material from the hairpin tubes as they are removed from the coating chamber 33. Upon removal from the coating chamber, the dryer 38 is applied to the coated tubes in order to cause the coating to quickly dry. A dryer may be of any of the various types which would cause a quick drying of the material. For example, it may take the form of a heater or a blower. The combination of the wiping step and the drying step helps to obtain a thin, uniform coating.

During the cooling process it is preferable to refrain from coating the entire hairpin or straight length tube. For purposes of further discussing this feature, the hairpin tube 16 are considered to have three sections, a U-shaped end section 39, a middle section 41, and a open end section 42. As part of the coating process, it is desirable that the entire middle section 41 (i.e. that portion of the hairpin tube which is between the tube sheets 13 and 14) be coated. It may not be desired that the U-shaped end section 39 be coated but, if formicary corrosion is a problem, then the coating of these sections would be desirable. In order to ensure the proper bonding of the return bend during the joining process, it is preferred that the open end section 42 not be coated prior to the joining process. One way to accomplish this is to provide a holding tool 43 that covers one or both of the tubes of the open end section 42 of the hairpin tube 16 such that when the hairpin is inserted into the coating chamber 13, the open end section 42 remains outside thereof. Other ways, of course, may be used in order to enable the coating of the middle section 21 without coating the open end section 42.

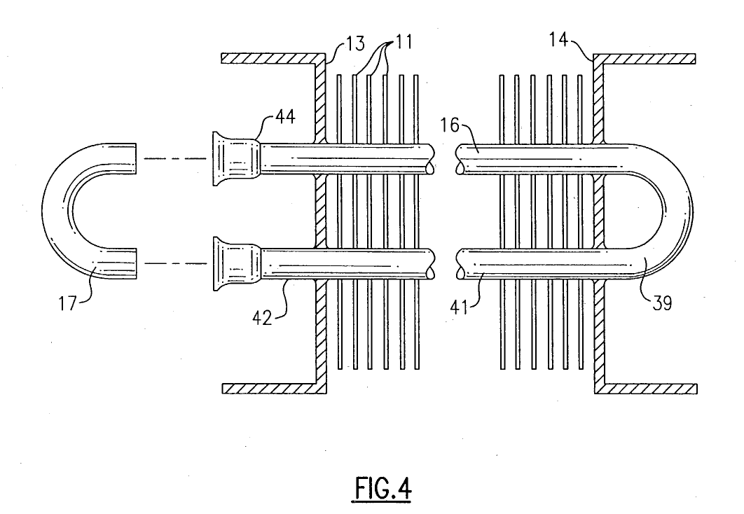

Referring now to FIG. 4, the heat exchanger coil is shown at a point in the process wherein the hairpin tubes 16 have been laced through the plate fins 11 and the tube sheets 13 and 14, and the hairpin tubes have been expanded to engage the plate fins 11 in a tight fit relationship. The middle section 41 has the coating applied for purposes of retarding or preventing corrosion between the tubes 16 and the plate fins. Further, the tube open ends 42 have been “belled” as shown at 44 in preparation for the joining of the return bend 17 thereto. Since the open ends 42 have not had a coating applied thereto, the return bend 17 can be easily bonded into place within the belled section 44 without complications that would otherwise occur if those portions had been coated.

While the invention has been shown and described with respect to a preferred embodiment thereof, it should be understood by those skilled in the art that the foregoing and various other changes, omissions and additions in the form of detail thereof may be made without departing from the true sprit and scope of the invention as set forth in the following claims.

We claim:

1. A fin and tube heat exchanger comprising:
a plurality of heat conductive plate fins having a plurality of holes therein, said fins being disposed between the inner surfaces of a pair of tube sheets and being parallel to each other and spaced at predetermined intervals to accommodate the flow of a first fluid between adjacent fins;
a plurality of heat transfer tubes disposed in respective ones of said holes in heat transfer relationship with said plate fins, said heat transfer tubes being adapted to have a second fluid flowing therethrough whereby heat is transferred between said first and second fluids;
said plurality of heat transfer tubes comprising:
a plurality of U-shaped hairpin tubes with a U-shaped first end section extending beyond an outer surface of one of the tube sheets and a pair of parallel open end sections extending beyond an outer surface of the other of said tube sheets; and
a plurality of U-shaped return bends interconnected to said open end section such that each return bend fluidly interconnects open ends of adjacent hairpins tubes;
wherein said hairpin tubes include a corrosion protective coating applied to outer surfaces thereof, at least over the portion thereof between said tube sheets, but not over those portions of said open end sections that are interconnected to said return bends.

2. A heat exchanger as set forth in claim 1 wherein said second fluid is a refrigerant.

3. A heat exchanger as set forth in claim 1 wherein said first fluid is air.

4. A heat exchanger as set forth in claim 1 wherein said corrosion protective coating is tin.

5. A heat exchanger as set forth in claim 1 wherein said U-shaped return bends are interconnected to said open end sections by way of brazing.

6. A heat exchanger as set forth in claim 1 wherein said corrosion protective coating is also applied to said U-shaped first end sections.

7. A method of manufacturing a heat exchanger coil of the type having a plurality of tubes and associated fins in close fit relationship therewith comprising the steps of:
uncoiling a roll of tubing;
cutting said tubing into tubes of predetermined lengths;
applying a corrosion protective coating on selected portions of said tubes;
lacing said tubes through a plurality of plate fins;
expanding said tubes such that their outer surfaces are in close contact with said plate fins;
belling open ends of said tubes; and
brazing return bends to said tube open ends.

8. A method as set forth in claim 7 wherein said plurality of tubes are at least partially composed of copper.

9. A method as set forth in claim 8 wherein said associated fins are at least partially composed of aluminum.

10. A method as set forth in claim 7 and including the step of wiping excess coating from said tubes after applying the coating thereto.

11. A method as set forth in claim 10 and including the step of curing the coating on said tubes prior to the lacing operation.

12. A method as set forth in claim 7 and including the step of bending said tubes into U-shaped hairpin tubes prior to said step of applying said corrosion protective coating.

13. A method as set forth in claim 12 wherein said hairpin tubes are comprised of a U-shaped end section, a middle section and an open end section, and further wherein said protective coating is applied to said middle sections.

14. A method as set forth in claim 13 wherein said coating is also applied to said U-shaped end sections.

15. A method as set forth in claim 13 wherein said coating is not applied to said open end sections.
